(19) United States
(12) Patent Application Publication
(10) Pub. No.: US 2023/0367561 A1
(43) Pub. Date: Nov. 16, 2023

(54) METHOD FOR GENERATING SOURCE CODE

(71) Applicant: dSPACE GmbH, Paderborn (DE)

(72) Inventor: Michael MAIR, Paderborn (DE)

(73) Assignee: dSPACE GmbH, Paderborn (DE)

(21) Appl. No.: 18/196,732

(22) Filed: May 12, 2023

(30) Foreign Application Priority Data
May 12, 2022 (DE) 10 2022 111 911.4

(51) Int. Cl. G06F 8/35; G06F 8/34

(52) U.S. Cl. CPC G06F 8/35; G06F 8/34

(57) ABSTRACT

A method for generating source code from one or more blocks of a block diagram, wherein received changes to model elements of the block diagram are stored. The generation of source code includes transforming the block diagram into an intermediate representation, successively optimizing the intermediate representation, and translating the optimized intermediate representation into source code. In this case, at least one plausibility rule is checked for changed model elements. If the plausibility rule is not satisfied, a warning is issued. A user can check mark the change to avoid seeing warnings repeatedly. Furthermore, the invention relates to a method for configuring a control unit, a computer program product and a computer system.

This nonprovisional application claims priority under 35 U.S.C. § 119(a) to German Patent Application No. 10 2022 111 911.4, which was filed in Germany on May 12, 2022, and which is herein incorporated by reference.

### BACKGROUND OF THE INVENTION

### Field of the Invention

The invention relates to the generation of executable code from a block diagram, in particular for programming control units.

### Description of the Background Art

Control units are used in a variety of applications to detect physical quantities of a process and/or to act on a process by means of connected actuators. For example, this could be an anti-lock braking system. The time constants that determine the dynamic behavior of the process often require cycle times of 1 ms or shorter, so that real-time capability of the control unit is usually required, especially if it is necessary to react to changed sensor values within a specified maximum latency. For cost reasons, control units often have microcontrollers with low memory and limited computing power, which is why the size and efficiency of the executable code is of great importance.

In order to accelerate the design of control units, control strategies are often developed using models in a computing environment such as MATLAB/Simulink. In this way, the process and/or controller or, in general, the behavior of the control unit can first be simulated and the presence of desired properties can be verified. In particular, the models can be block diagrams, which include blocks that perform operations such as calculations, wherein a block can, for example, calculate an output signal from several input signals. Typically, block diagrams are executed cyclically, wherein all blocks are permanently held in memory and each block is executed once per time step. In particular, a block may apply one or more operations to input signals from the last step in order to generate output signals from the current step. Source code for programming the control unit can be generated directly from the models by a code generator. For example, a code generator for generating production-quality source code is known from the publication “Production Quality Code Generation from Simulink Block Diagrams”, Proceedings of the 1999 International Symposium on Computer Aided Control System Design, Kohala Coast, Hawai'i, by H. Hanselmann et al.

During modeling, the model elements of a block diagram can be provided with additional parameters or code generation settings to adapt the generated source code. For example, for a block variable, in addition to a data type, other properties such as a range of values or a scale can also be specified. The optimization of the code generator can also be influenced, for example by using a tag to indicate whether a variable can be combined with other variables. Block diagrams are typically hierarchical, wherein a variety of subordinate blocks implement the functionality of a parent hierarchical block. Preferably, hierarchical blocks can also be nested, thus allowing for a structuring of the block diagram. In particular, a function can be created in the source code from a hierarchical block. The hierarchical block or a child block can be used to specify properties of the function, such as whether it can be moved or does not trigger side effects in other parts of the block diagram. Side effects can arise, for example, from the fact that one block writes to a memory variable and another block reads from this memory variable.

Due to the complexity of modern control algorithms, block diagrams can contain several thousand blocks, although individual sub-functionalities can also be repeated in different parts of the block diagram. Therefore, it is a good idea to copy a hierarchical block, once created, from one place in the block diagram to another. However, this can lead to one or more code generation settings or to their values ceasing to apply for the copied block. If code generation is carried out now, this can lead to incorrect code in extreme cases.

### SUMMARY OF THE INVENTION

It is therefore an object of the present invention to further develop the prior art and, in particular, to warn the user of presumably incorrectly parameterized blocks before these can influence code generation.

In an exemplary embodiment, a computer-implemented method is provided for generating source code from one or more blocks of a block diagram, wherein the generation of source code includes evaluating at least one code generation setting, transforming the block diagram into an intermediate representation, successively optimizing the intermediate representation while taking into account at least one code generation setting and translating the optimized intermediate representation into source code. The method can comprise the following steps: opening the block diagram in a model editor, receiving a change to a model element, wherein the model element is parameterized with at least one code generation setting, saving the change to a database, generating source code, checking that the changed model element satisfies a plausibility rule, and if the plausibility rule is not satisfied, issuing a warning and/or marking the source code as invalid.

In particular, the model elements can be blocks, which often comprise one or more block variables. Block variables can be explicitly defined in the block or can be generated automatically, for example by means of a signal connection, where a block variable, i.e., a block output variable, is conveniently generated for an output signal of a block. Some blocks, such as a delay block, also have state variables.

By checking according to the invention whether the changed model element satisfies a plausibility rule, a user can be made aware of potentially problematic models and check them in a targeted manner. In particular, adding a state variable or opening a data flow from a hierarchical block is potentially problematic. Apparently unproblematic changes are readily accepted—by taking into account the model semantics, the number of changes to be verified is significantly reduced.

Preferably, a check mark can be saved in the database for a change, with the plausibility rule being satisfied if the change has been check marked. Thus, there is no warning and/or marking of the source code as invalid for any changes that have been check marked. As soon as the user has check marked a change, it is expedient that no warning is issued until another change is made.

It is particularly preferable for a user interface to be displayed in order to receive a check mark for a change, preferably displaying a section of the generated source code, which in particular includes source code generated from the changed model element. By displaying the source code for the environment of the changed model element, the user can easily see any effects on the code.

The change can involve copying a model element and/or all code generation settings of a model element. By copying the model element with all the code generation settings, or simply copying all the code generation settings of another model element, they can potentially contain assertions that no longer apply to the changed model element. Therefore, it is advantageous to check these changes by means of a plausibility rule.

The plausibility rule can be satisfied if, for a model element that has at least one variable, the value range of the at least one variable is greater than or equal to the value range of an input variable after applying the calculation made in the changed model element and/or at least one code generation setting in the changed model element has a different value from the original model element. A model element that performs a calculation also transforms the value ranges in a known way; this makes it possible to detect misspecifications such as an output value range that is obviously too small on the basis of the input value range(s). Verification of the value ranges can preferably be carried out after an intermediate representation has been generated. In the case of copying model elements or all code generation settings, checking whether at least one code generation setting has been changed is useful as a plausibility rule because it ensures that the user has edited the code generation settings at least once.

The model element can be a hierarchical block whose functionality is implemented by one or more child blocks. Because hierarchical blocks are often implemented as standalone functions, their code generation settings can often include potentially problematic assertions. In order to avoid incorrect specifications, it is advisable to check at least one plausibility rule for hierarchical blocks.

If the change is an addition of a child block, the plausibility rule may not be satisfied if the added block includes a state variable and/or a data connection to a model element outside the hierarchical block. For example, a data connection can be caused by accessing a memory variable that can potentially be accessed outside the hierarchical block. What is particularly problematic here is that unlike with a signal connection, this is not easily recognizable.

If the hierarchical block has a code generation setting that indicates movability and/or freedom from side effects, the plausibility rule may not be satisfied if a child block of the hierarchical block contains a variable for which the code generation settings have been changed into a possible combination of variables and/or a memory address of a variable. In particular, allowing variables to be grouped together during optimization can cause undesirable side effects. If this has been allowed for child blocks of a hierarchical block, assurances about freedom from side effects are risky and should be avoided. The data flow can also change due to a change in the memory address.

Preferably, a change command of the model editor can be linked to a function in a scripting environment that stores at least the changed model element, an original code generation setting and a changed code generation setting in the database. This enables transparent storage of the data affected by the change for the user. Based on the stored data, the user can later check the changes and, if necessary, undo them.

If the change command is to copy the model element, then the changed model element with all code generation settings, the original model element and all code generation settings of the original model element can be stored in the database. Even if the original model element is changed later, the starting point can be reliably detected.

Preferably, checking that the changed model element satisfies at least one plausibility rule is triggered by receiving a command to generate source code, wherein the command can be received through a graphical user interface and/or an application interface. It is advantageous if the user can edit freely and without delay. As soon as the command to generate source code is given, it can be assumed that the state is finished from the user's point of view, for which a plausibility check is appropriate.

If the block diagram contains a large number of model elements, it is advantageous that at least one plausibility rule is checked for each changed model element and/or each saved change. Even after a longer period of processing, the stored information makes it possible to check the plausibility.

In examples of the invention, it may be provided that potentially problematic code generation settings are stored separately from other settings and/or model elements. These code generation settings can then be checked for plausibility at a later date, for example by using a counter of model versions. This reduces the verification effort, especially for large models, and also enables further tests, such as a plausibility check after each major change to the model version.

The invention further relates to a method for configuring a control unit, wherein the control unit comprises at least one computing unit and preferably has at least one sensor and/or at least one actuator in order to acquire data of a physical process and/or act on the latter, the method can comprise the steps of: importing a block diagram, generating a source code using a method according to the invention, compiling the source code for the computing unit so that an executable code is generated, transferring the executable code to the control unit, and storing the executable code on a non-volatile memory of the control unit and/or executing the executable code by means of the control unit computing unit.

Further, the invention relates to a computer program product having a computer-readable storage medium on which commands are embedded which, when executed by a processor, cause the processor to be configured to perform the method according to the invention.

Furthermore, the invention relates to a computer system comprising a human-machine interface, a non-volatile memory and a processor, wherein the processor is set up to perform the method according to the invention.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 is an exemplary embodiment of a computer system according to the invention;

FIG. 2 is a schematic representation of the software components that are preferably present on the computer system;

FIG. 3 is a schematic flow chart of an embodiment of the method for generating source code according to the invention; and

FIG. 4 is an example of a hierarchical block diagram.

### DETAILED DESCRIPTION

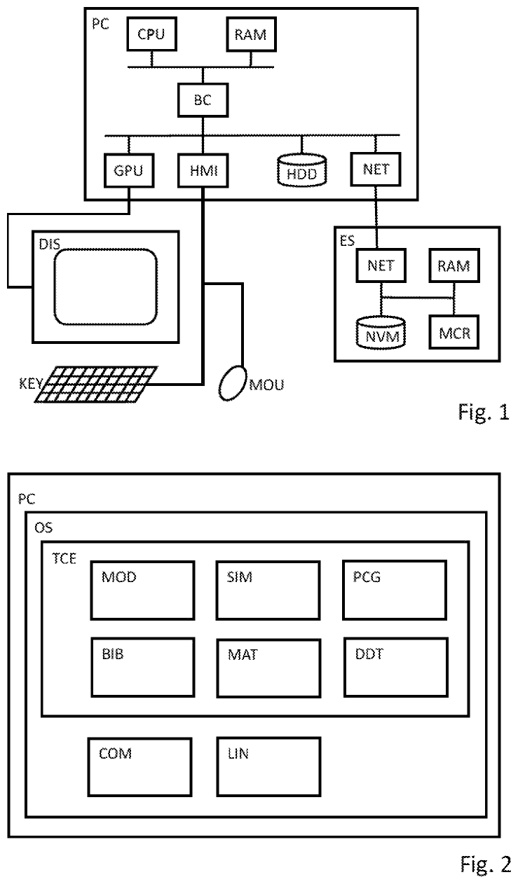

FIG. 1 shows a preferred embodiment of a computer system PC. This has a processor CPU, which can be realized in particular as a multi-core processor, a working memory RAM and a bus controller BC. Preferably, the computer system PC is designed to be operated manually directly by a user, wherein a monitor DIS is connected via a graphics card GPU and a keyboard KEY and a mouse MOU via a peripheral interface HMI. In principle, the human-machine interface of the computer system PC could also be designed as a touch interface. The computer system also includes a non-volatile data store HDD, which can be designed in particular as a hard disk and/or solid state disk, as well as an interface NET, in particular a network interface. A control unit ES can be connected via the interface NET. In principle, one or more arbitrary interfaces, in particular wired interfaces, can be present on the computer system PC and can be used for connection to a control unit ES. Conveniently, a network interface based on the Ethernet standard can be used; the interface NET can also be designed wirelessly, in particular as a WLAN interface or according to a standard such as Bluetooth.

The control unit ES can be designed as a series control unit or as an evaluation board for a target platform. Conveniently, it includes an interface NET for connecting to the computer system PC, a microcontroller MCR with an architecture different from the processor of the computer system, a working memory RAM and a non-volatile memory NVM. The presence of a control unit is not required for the method according to the invention, but it allows for a processor-in-the-loop test of the generated code.

FIG. 2 shows a diagram of the software components preferably installed on the computer system PC. These use mechanisms of the operating system OS, for example, to access the non-volatile data store HDD or to establish a connection to an external computer via the network interface NET.

A technical computing environment TCE enables the creation of models and the generation of source code from the models. In a modeling environment MOD, models of a dynamic system can preferably be created via a graphical user interface. In this case, these can be block diagrams, which comprise several blocks and describe the temporal behavior and/or internal states of a dynamic system. At least some of the blocks are connected by signals, i.e., directional connections for the exchange of data, which can be scalar or composite. Data or signals can be transmitted via a signal connection; in this case, a first block outputs a value or, depending on the definition, several related values, and a second block receives them and takes them into account when determining one or more related output values of the second block. Signals can contain scalar variables and/or structured data types such as arrays, such as is the case with a bus.

Blocks can be atomic, i.e., from the point of view of the surrounding blocks, they can form a unit in which all input signals must be present at the beginning of a calculation step and all output signals are present at the end of a calculation step. When block diagrams are hierarchical, a large number of blocks in a child level can describe the structure of a block in a parent level. Hierarchical or composite blocks, even if they are atomic, can comprise a large number of blocks in a child level. In particular, composite blocks can be subsystems; Subsystems can have additional properties, such as being implemented in a separate function and/or triggering the execution of the subsystem via a dedicated signal. In subsystems, special blocks can be arranged to further specify the properties of the subsystem. The computing environment TCE comprises one or more libraries BIB from which blocks or elements can be selected for building a model. In a scripting environment MAT, commands can be entered interactively or through a batch file to perform calculations or change the model. The computing environment TCE also includes a simulation environment SIM that is set up to interpret or execute the block diagram in order to investigate the temporal behavior of the system. These calculations are preferably performed with high-precision floating-point numbers on one or more cores of the microprocessor CPU of the computer system.

With the help of a code generator PCG, a source code can be generated, preferably, in a programming language such as C. In a definition data collection DDT, additional information about the model, in particular about the block variables, is conveniently stored. It is convenient to assign value ranges and/or scales to the block variables to support a calculation of the model with fixed-point arithmetic instructions. Desired properties of the source code, e.g., conformity to a standard such as MISRA, can also be set or stored in the definition data collection DDT. Conveniently, each block variable is assigned to a predefined variable type, and one or more desired properties, such as the permissibility of optimizations such as a combination of variables, are set. The code generator PCG preferably evaluates the settings of the definition data collection DDT and takes them into account when generating the source code. The definition data collection DDT can have a tree structure or may be stored as a simple file in a memory of the computer system; alternatively, it may be provided that the definition data is stored in a dedicated database system. The definition data collection may have a program interface and/or import/export functions.

The computer system PC has a compiler COM and a linker LIN, which are conveniently set up for the creation of binaries executable on a control unit ES and/or the computer system PC. In principle, a large number of compilers can be available, in particular cross-compilers for different target platforms, in order to support control units or evaluation boards ES with different processor architectures. This makes it possible to test the generated code on the processor CPU of the computer system (software-in-the-loop test) or to test it on the control unit (processor-in-the-loop test).

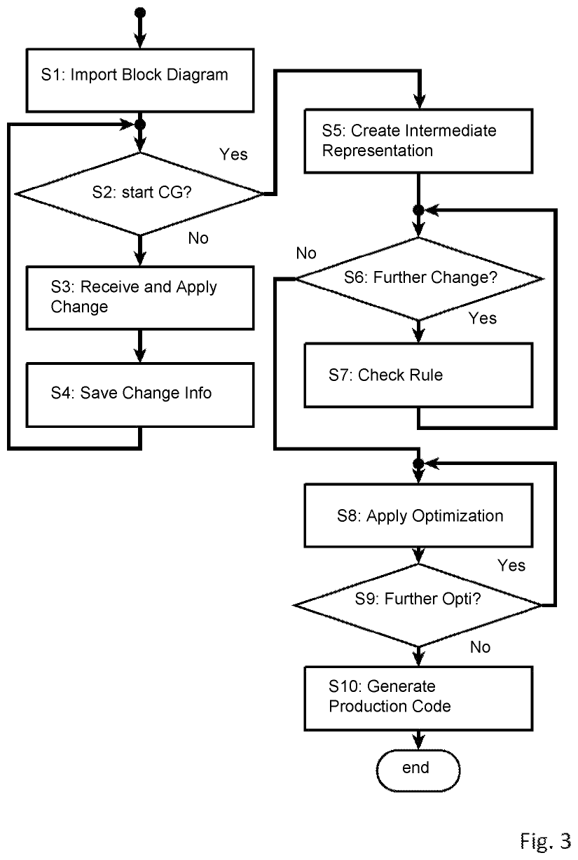

FIG. 3 shows a schematic flow chart of an embodiment of the method according to the invention for generating source code. The method can be carried out entirely by a processor of an exemplary embodiment of the computer system PC; however, it may also be provided to be executed in a client-server environment with one workstation and one or more servers connected via a network, wherein in particular computationally intensive steps are suitably carried out on the servers.

In step S1 (Import Block Diagram), a block diagram is imported. The block diagram preferably includes one hierarchical block and can contain a variety of other hierarchical blocks. Conveniently, importing the block diagram also includes reading at least one code generation setting, such as the data type of a variable, in particular from the definition data collection DDT.

Step S2 (Start CG?) determines whether code generation should take place. For example, code generation can be started in a graphical user interface by clicking a button. It can also be provided for code generation to be requested by calling a function in a scripting environment. The code generator can support various code generation modalities such as standard code generation, Classic AUTOSAR code generation, and/or Adaptive AUTOSAR code generation. Depending on the mode, source code with different properties is then generated, in particular to comply with the conventions of different software environments such as an AUTOSAR runtime environment. Also, the generation of code in a hardware description language or a configuration of a programmable hardware device can be provided as an alternative code generation modality. If code generation is to take place, the next step is S5 (Generate Intermediate Representation).

As long as no code generation has been started, the block diagram can be customized in the modeling environment. In step S3 (Receive and Apply Changes), the user can make various changes to the block diagram, for example via a graphical user interface of the modeling environment. As soon as the change has been received and applied, information about the change is saved in a database in step S4 (Save Change Info). For example, if the change is to copy the model element, it is convenient to store the changed model element with all the code generation settings and the original model element with all the code generation settings of the original model element in the database. After each change, step S2 verifies that a code generation command has been received and that step S5 should be executed.

In step S5 (Create Intermediate Representation), the selected model is transformed from one or more blocks of the block diagram BLD into an intermediate-representation IR, which preferably includes one or more hierarchical graphs. In particular, this can be a data flow graph, a control flow graph or a tree structure. In addition to the BLD block diagram, additional information from a definition data collection DDT is also taken into account or incorporated into the intermediate representation when generating said intermediate representation. This can also include situations where elements are generated based on information in the definition data collection DDT.

In step S6 (Further change?), it is checked whether the user has made changes to the block diagram. If this is the case (Yes), at least one plausibility rule for the change is checked in step S7 (Check Rule). For example, for an inserted block, it can be checked whether the value range of a block output variable is compatible with the value range resulting from the input variables. If an inserted block is part of a parent hierarchical block, it is convenient to check plausibility rules for code generation settings of the hierarchical block as well. For example, if the inserted block accesses an external memory variable, marking the parent hierarchical block as side-effect-free is potentially problematic. In principle, it may also be provided that the check of plausibility rules is carried out in whole or in part before an intermediate representation is generated. The order shown here has the advantage that during the generation of the intermediate representation, some code generation settings can be propagated between blocks connected by signals.

In step S8 (Apply Optimization), the hierarchical graphs are optimized to reduce the number of variables required and/or memory consumption, such as stack allocation, and/or the number of operations or processor instructions and/or the execution time of the source code. This optimization can include a large number of intermediate steps in which further intermediate representations between model/block diagram and source code/program text are generated. In particular, it may be provided to convert a set of original hierarchical graphs into another set of changed hierarchical graphs in each intermediate step, wherein one or more optimization rules are applied. The optimization rules to be applied can be stored in the definition data collection and/or follow a preset standard workflow.

In step S9 (Further Opti?) it is checked whether another optimization rule has to be applied. Various strategies or optimization rules such as “constant folding” or the elimination of “dead code” can be applied to optimization. If at least one optimization rule has not yet been applied or is to be applied again, step S8 is repeated. Otherwise, the process continues in step S10. It may also be provided to already apply individual optimizations as part of the transformation to an intermediate representation of step S5, especially if they can be performed more easily on a block diagram representation.

In step S10 (Generate Production Code), the optimized intermediate representation IR or the optimized hierarchical graphs, which result from all the intermediate steps performed, are translated into source code PCO of a textual programming language, such as C code in particular. In this step, too, further optimization can take place, in particular in such a way that the generated instructions represent a subset of the instructions that are basically encompassed by the language and/or that the generated control structures represent a subset of the control structures that are basically encompassed by the language. This makes it possible to comply with well-defined rules. Alternatively or additionally, it may be provided to generate additional information, such as a reference between the program line and the block of the block diagram, and in particular to integrate it into the source code in the form of comments in order to improve the readability of the source code PCO and/or to simplify debugging.

During or after code generation, information about the current block diagram or code generation results, such as warnings, can be stored in the definition data collection. This information can be used, for example, to influence a compilation of the generated source code or to provide meta information for other tools, such as calibration information in ASAP2 format or information to create an intermediate layer for a runtime environment according to the AUTOSAR standard.

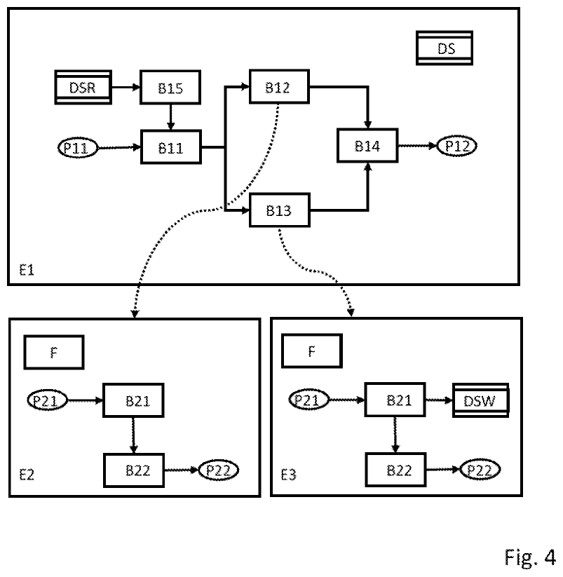

FIG. 4 shows an example of a hierarchical block diagram. The top level E1 includes input port P11, output port P12, through which signals or data are received and output, and blocks B11, B12, B13, B14, B15, which apply operations to input signals in order to generate output signals. Here, the two blocks B12 and B13 are implemented as hierarchical blocks in subordinate hierarchical levels E2 and E3. Furthermore, the top level E1 of the block diagram includes a data store block DS (this can also be referred to as a DataStoreMemory block), in which data can be stored, as well as a data store read block DSR for reading from the data store DS, which is connected to block B15.

The hierarchical block B12 comprises the blocks represented in level E2 input port P21, output port P22, blocks B21 and B22, and a function block F. The hierarchical block B13 comprises the blocks represented in level E3, namely, in addition to the blocks contained in B12, an additional data store write block DSW for writing to the data store DS. The data store DS thus represents a global memory or a global variable through which the hierarchical block B13 can exchange data with the environment without this becoming visible via a signal connection.

Function block F of block B12 can be parameterized with various code generation settings or properties of the function. In particular, it may be specified that the function may be moved (movable) and/or that the function is free of side effects (Side_Effect_Free). If block B13 was now created by copying and pasting block B12 and then inserting the data store write block, the code generation settings may have been mistakenly applied. By alerting the user to the potentially critical settings in the function block, specification errors caused by copying and making changes can be avoided.

The method according to the invention makes it possible to track changes made compared to a defined modeling state, such as in particular a copy & paste of a block, including the type of change. Direct changes to individual model elements as well as changes to subordinate hierarchical levels can be taken into account and code-generation settings can be checked for plausibility. On this basis, the user can specifically check potential sources of problems and define a well-defined modeling status in this regard.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A computer-implemented method to generate source code from one or more blocks of a block diagram, wherein the generation of source code includes evaluating at least one code generation setting, transforming the block diagram into an intermediate representation, successively optimizing the intermediate representation taking into account at least one code generation setting, and translating the optimized intermediate representation into source code, the method comprising:
opening the block diagram in a model editor;
receiving a change to a model element, the model element is parameterized with at least one code generation setting;
saving the change to a database;
generating source code;
checking that the changed model element satisfies a plausibility rule; and
issuing, if the plausibility rule is not satisfied, a warning and/or marking the source code as invalid.

2. The method according to claim 1, wherein a check mark is stored in the database for a change, and wherein the plausibility rule is met if the change has been checked, so that no warning and/or marking of the source code as invalid is given for checked changes.

3. The method according to claim 1, further comprising displaying a user interface to receive a check mark for a change or for representing a section of the generated source code, which includes source code generated from the changed model element.

4. The method according to claim 1, wherein the change involves copying a model element and/or all code generation settings of a model element.

5. The method according to claim 4, wherein the plausibility rule is satisfied if, for a model element having at least one variable, the range of values of at least one variable is greater than or equal to the range of values of an input variable after applying the calculation made in the changed model element and/or at least one code generation setting in the changed model element yields a different value from the original model element.

6. The method according to claim 1, wherein the model element is a hierarchical block whose functionality is implemented by one or more subordinate blocks.

7. The method according to claim 6, wherein the change is an addition of a subordinate block, and wherein the plausibility check is not satisfied if the added block includes a state variable and/or a data connection to a model element outside the hierarchical block.

8. The method according to claim 6, wherein, if the hierarchical block has a code generation setting indicating a movability and/or freedom from side effects, the plausibility check is not satisfied if a subordinate block of the hierarchical block comprises a variable for which the code generation setting was changed to a possible compilation of variables and/or a memory address of a variable was changed.

9. The method according to claim 1, wherein a function in a scripting environment is linked to a change command of the model editor, which stores at least the changed model element, an original code generation setting, and a changed code generation setting in the database.

10. The method according to claim 9, wherein, if the change command is a copy of the model element, the changed model element with all code generation settings, the original model element and all code generation settings of the original model element are stored in the database.

11. The method according to claim 1, wherein checking whether the changed model element satisfies at least one plausibility rule is triggered by receiving a command to generate source code, and wherein the command is adapted to be received via a graphical user interface and/or an application interface.

12. The method according to claim 1, wherein the block diagram comprises a large number of model elements, and that at least one plausibility rule is checked for each changed model element and/or saved change.

13. A method to configure a control unit, the control unit comprising at least one computing unit and comprising at least one sensor and/or at least one actuator to acquire data of a physical process and/or act on the latter, the method comprising:
importing a block diagram;
generating a source code via the method according to claim 1;
compiling the source code for the computing unit so that an executable code is generated;
transferring the executable code to the control unit; and
storing the executable code on a non-volatile memory of the control unit and/or executing the executable code via the control unit computing unit.

14. A computer program product comprising a computer-readable storage medium on which commands are embedded which, when executed by a processor, cause the processor to be configured to perform the method according to claim 1.

15. A computer system comprising a man-machine interface, a non-volatile memory, and a processor, wherein the processor is set up to perform the method according to claim 1.
